(19) United States
(12) Patent Application Publication
(10) Pub. No.: US 2026/0267558 A1
(43) Pub. Date: Sep. 10, 2026

(54) HIERARCHICAL STORE QUEUE

(71) Applicant: Google LLC, Mountain View, CA (US)

(72) Inventors: Vineeth Thamarassery Mekkat, San Ramon, CA (US); Dung Quoc Nguyen, Austin, TX (US); Chanchal Kumar, San Jose, CA (US); Leigang Kou, Austin, TX (US)

(21) Appl. No.: 19/162,277

(22) PCT Filed: Mar. 6, 2023
(86) PCT No.: PCT/US2023/014594

§ 371 Date: Sep. 4, 2025

(51) Int. Cl. G06F 3/06

(52) U.S. Cl. CPC G06F 3/0659; G06F 3/0604; G06F 3/0679

(57) ABSTRACT

Methods, systems, and apparatus, including computer programs encoded on a computer storage medium, on a processor using a hierarchical store queue. In one aspect, a system comprises a processor that is configured to receive a load instruction having an address corresponding to an entry in the hierarchical store queue. The processor performs the store-to-load forwarding process for the load instruction including performing a hierarchical search to find the entry in the hierarchical store queue, where performing the hierarchical search includes searching a first partition of the hierarchical store queue for the entry before searching a second partition of the hierarchical store queue. The processor reads a value of the entry from the hierarchical store queue for the load instruction.

### BACKGROUND

This specification relates to techniques for performing memory operations using a hierarchical store queue.

In modern computing, loading from memory and storing to memory are performance critical memory operations in a processor. A store queue of a load store unit (LSU) within the processor tracks inflight store entries in a processing window to ensure correctness of data written to memory by store instructions in the presence of Out of Order (OOO) execution. The store queue of the LSU can ensure the correctness of data when reading data from memory is requested by a store instruction. A conventional technique to optimize for reading the data from memory is performing a store-to-load forwarding (STLF) process. STLF allows data to be forwarded from a store instruction in the window to a load instruction within a processor, rather than writing the data out to memory with the store instruction and reading the same data back in with the load instruction.

As the size of the processing window increases, in order to track the inflight store entries, the processor can increase the store queue size to accommodate the larger number of entries. However, increasing the store queue size can result in increased latency in performing STLF, as the processor must read through a larger number of store queue entries. On the other hand, smaller store queues may enable a faster performance of STLF, but smaller store queues can cause their performance losses by introducing more blocking of store instructions when the store queue is full.

### SUMMARY

This specification describes a system for performing memory operations using a hierarchical store queue having multiple partitions, which can significantly improve the performance of STLF for large processor windows. When using a hierarchical store queue, the system can speed up the search for store instructions by first searching a first partition for the store queue, where the store instruction is more likely to be found. If the store instruction is not in the first partition, the system can search other partitions of the store queue. A hierarchical structuring method as disclosed herein can achieve increased efficiency in the processor by improving STLF performance.

Particular embodiments of the subject matter described in this specification can be implemented so as to realize one or more of the following advantages.

The described methods and systems improve the performance of store queues included in processors e.g., store queue with large numbers of instructions associated with a large processing window size. For example, the described methods and systems allow for more efficiently performing STLF by dividing the store queue into two partitions. The system performs STLF in the first partition at a relatively faster rate than the second partition. By performing STLF faster in the first partition, the system increases the overall efficiency of the store queue by finding the store instruction at a faster rate, which decreases latency in writing data to memory.

Additionally, if the system searches and locates the data to be forwarded in the first partition, the system can conserve power by refraining from searching for the data in the second partition.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example system.

FIG. 2 is an example diagram of a logically divided hierarchical store queue structure.

FIG. 3 is an example diagram of a physically divided hierarchical store queue structure.

FIG. 4 is a flow diagram of an example process for performing memory operations on a processor using a hierarchical store queue.

Like reference numbers and designations in the various drawings indicate like elements.

### DETAILED DESCRIPTION

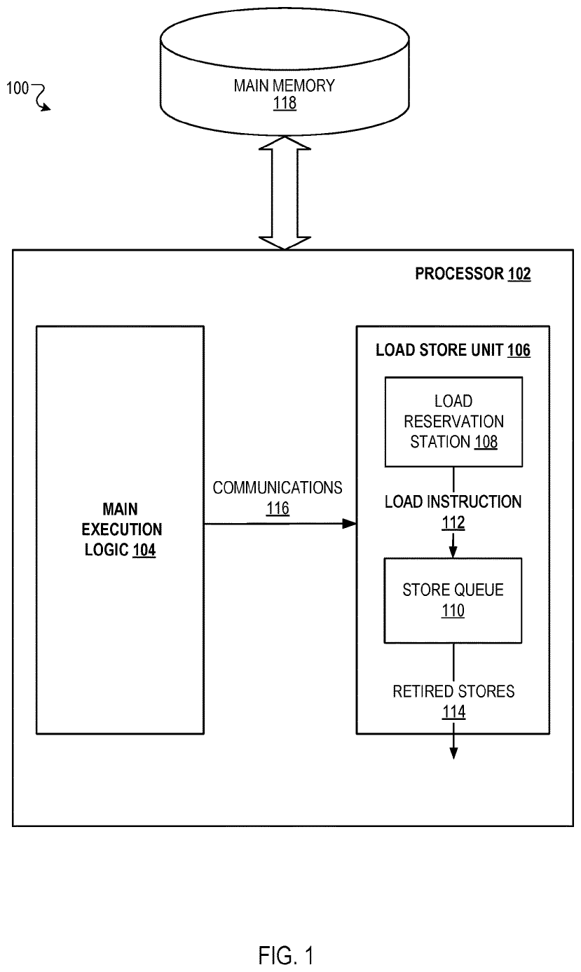

FIG. 1 shows an example system 100. The system 100 is an example of a system in which the systems, components, and techniques described below are implemented.

The system 100 includes a processor 102 coupled to a main memory 118, e.g., a cache, random-access memory (RAM), read-only memory (ROM), etc. The processor 102 can perform a STLF process using the load store unit (LSU), as described above. The processor 102 contains a load store unit (LSU) 106 and a main execution logic 104.

The LSU 106 communicates with the main execution logic 104 to receive and send data. For example, communications 120 between the LSU 106 and the main execution logic 104 can include store instructions, load instructions, stored values, etc. The processor 102 communicates with the main memory 118 to receive and send data. For example, the communications 120 between the processor 102 and the main memory 118 can include memory addresses, stored values, etc.

The LSU 106 contains a load reservation station 108 and a store queue 110.

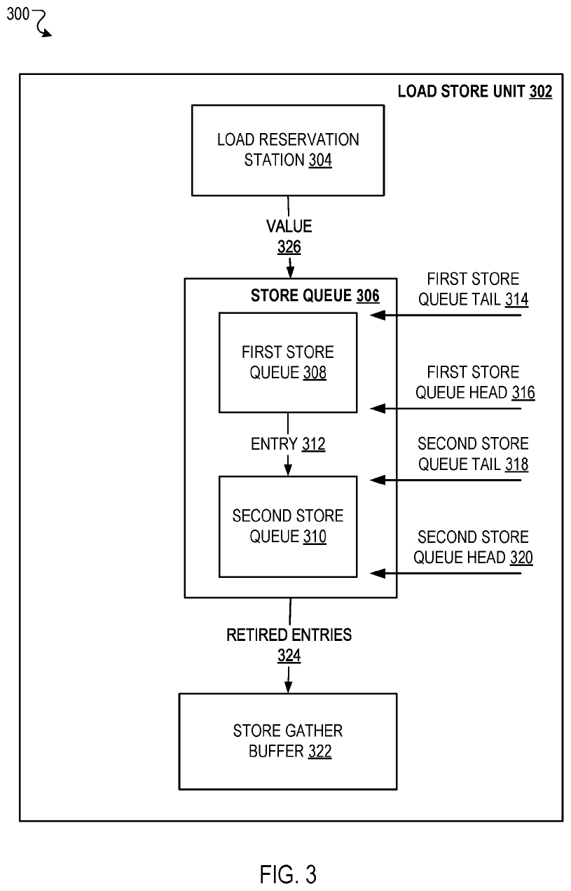

The store queue 110 can include a content-addressable memory (CAM) structure which holds in-flight store instructions, which can support simultaneous searches. The store queue 110 is associated with at least one tail pointer that denotes the entry that the processor 102 most recently added into the store queue 110. The processor 102 obtains the most recently added entry from the load reservation station 108. Additionally, the store queue 110 is associated with at least one head pointer that denotes the oldest entry in the store queue 110 (e.g., the entry that the processor added last). Conventionally, the processor 102 retires entries (e.g., retired stores 114) from the store queue 110 in a first-in-first-out (FIFO) fashion. The processor 102 can retire the entry at the head pointer (e.g., the oldest entry). In some examples, the processor 102 retires the entry to a store gather buffer, as described in further detail with reference to FIG. 3.

Regardless of implementation, the load reservation station 108 at the LSU 106 can receive communications 116 from the main execution logic to extract or read data. The load reservation station 108 sends a load instruction 112 for the data to the store queue 110. The load instruction 112 includes an address corresponding to an entry in the store queue 110 associated with the data.

In some implementations, the processor 102 can perform STLF for one or more of the entries of the load instruction 112 using the store queue 110. The store queue 110 keeps track of pending store instructions within the processing window. When a subsequent load instruction is executed, the processor 102 can check the pending store instructions of the store queue 110 to determine whether the data to be loaded is present in the store queue 110. If the data is present in a pending store instruction, the processor 102 can perform STLF by retrieving the data from a pending store instruction of the store queue 110 rather than from the main memory 118. The processor 102 can forward data from the pending store instruction to the load instruction 112, instead of writing the data out to main memory 118 and reading the same data back in with the load instruction 112, which increases efficiency in the store queue 110.

In this example, the processor 102 performs the STLF process for the load instruction 112 by performing a hierarchical search of the store queue 110 (e.g., a hierarchical store queue). In this case, the hierarchical store queue 110 is divided into a first partition and a second partition. The processor 102 initially searches the first partition for the entry included in the load instruction 112 before searching the second partition of the hierarchical store queue 110. The first partition can be smaller than the second partition, and the first partitions includes the most recently stored entries, which are more likely to be requested by the load instruction 112. Thus, the processor 102 can perform STLF more efficiently, which can decrease the latency of performing STLF in the hierarchical store queue overall.

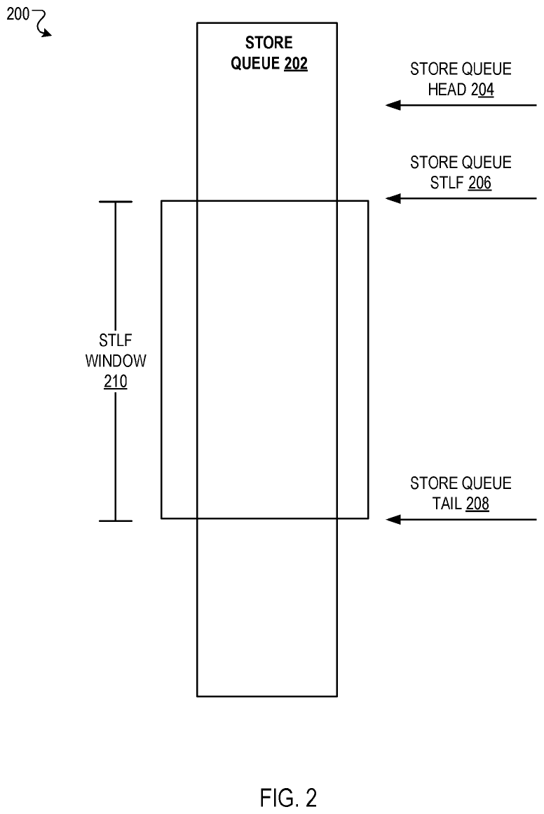

In some implementations, the store queue 110 is divided logically into the two partitions. The store queue 110 is divided using the head pointer and the tail pointer of the store queue 110, along with a third pointer that denotes the first entry to search in the first partition, which will be described in further detail with reference to FIG. 2.

Alternatively, in another implementation, the hierarchical store queue 110 is divided physically into the two partitions, where each partition is a separate store queue device. Each store queue device is associated with a head pointer and a tail pointer associated with storing and retiring the entries of the hierarchical store queue 110, which will be described in further detail with reference to FIG. 3.

FIG. 2 is an example diagram of a logically divided hierarchical store queue structure. For convenience, the diagram 200 will be described as being implemented by a processor. For example, a processor, e.g., the processor 102 of FIG. 1, appropriately configured in accordance with this specification, can implement the diagram 200.

Conventional store queues have been implemented as a monolithic circular queue that is associated with a store queue tail pointer and a store queue head pointer. An offset ranging between the store queue tail pointer 208 and the store queue head pointer 204 indicates a region of the store queue 202 with active entries. The location of the store queue head pointer 204 indicates the oldest entry in the processor, and the location of the store queue tail pointer 208 indicates the most recently added entry in the processor (e.g., the newest entry).

In this example, the store queue 202 is a monolithic circular queue that is divided logically into a first partition and a second partition by a third pointer (e.g., store queue STLF pointer 206). The first partition ranges from the store queue tail pointer 208 to the store queue STLF pointer 206, and the second partition ranges from the store queue STLF pointer 206 to the store queue head pointer 204. The store queue STLF pointer 206 denotes a first entry for the processor to search in the first partition when performing STLF. The first partition is smaller than the second partition.

The store queue STLF pointer 206 is located at an offset from the store queue tail pointer 208, where the offset is the STLF window 210. The STLF window 210 can be constructed globally to the processor. In this case, the offset between the STLF pointer 206 and the store queue tail pointer 208 is a fixed value of the processor, where the STLF window 210 applies to each load instruction and each active entry for performing STLF. Alternatively, the STLF window can be local to each load instruction. In this case, the processor can set a relatively smaller offset, resulting in a smaller STLF window 210, which can increase the efficiency of performing STLF at the first partition.

The processor performs STLF by searching for active entries within the STLF window 210, starting with the entry at the store queue STLF pointer 206. The first partition is smaller than the second partition, which increases the efficiency of performing STLF in the first partition and in the overall store queue 202. As such, the first partition supports relatively faster STLF performance in comparison to the second partition (e.g., the second partition supports slower STLF). The processor performs the hierarchical search by determining whether the entry from the load instruction is not located in the first partition. If not, only then does the processor search the second partition instead from a location indicated by the head pointer.

For example, a store queue 202 can have a store queue size of 128 entries and a maximum STLF window size of 64. If the store queue STLF pointer 206 is located at an entry of index 100 (e.g., the 100^{th} entry in the store queue), the processor determines that the youngest entry (e.g., the most recently added entry) is at entry of index 100. The processor determines that the current STLF window 210 spans a certain number of entries (e.g., 36 entries) by calculating the difference between the entry number and the maximum STLF window size (e.g., 100-64). The processor can perform STLF more efficiently in the first partition, as the first partition contains a relatively lower number of entries (e.g., 36 entries) than the second partition (e.g., 64 entries).

This technique retires stored entries in a first-in first-out (FIFO) manner. The processor can receive a store instruction containing new entries, and the processor stores the new entries into the store queue 202. Accordingly, as the processor stores the new entries, the store queue tail pointer 208 shifts within the circular queue to indicate the newest entry. As the store queue tail pointer 208 shifts, the store queue STLF pointer 206 also shifts to maintain the maximum STLF window size. The store queue head pointer 204 also shifts within the circular queue, such that the STLF window 210 contains active entries (e.g., not retired entries).

In order to maintain the maximum STLF window size, the processor retires entries from the store queue 202 to the store gather buffer. The processor retires the oldest entries in the store queue 202 first, where the oldest entry is indicated by the store queue head pointer 204. Once the processor retires the oldest entries in the store queue 202, the processor can write the new entries from the store instruction in the hierarchical store queue.

FIG. 3 is an example diagram of a physically divided hierarchical store queue structure. For convenience, the diagram 300 will be described as being implemented by a processor. For example, a processor, e.g., the processor 102 of FIG. 1, appropriately configured in accordance with this specification, can implement the diagram 300.

The load store unit (LSU) 302 includes the load reservation station 304, the store queue 306, and the store gather buffer 322.

In this implementation, the store queue 202 is divided physically into separate hierarchical store queue devices, a first store queue 308 and a second store queue 310. The store queue devices are of unequal sizes, and the first store queue 308 is smaller than the second store queue 310. The first store queue 308 contains a first store queue tail pointer 314 and a first store queue head pointer 316, and the second store queue 310 contains a second store queue tail pointer 318 and a second store queue head pointer 320. The first store queue tail pointer 314 and the second store queue tail pointer 318 each indicate the most recent entry in the respective partition. The first store queue head pointer 316 and the second store queue head pointer 320 each indicate the oldest entry in the respective partition.

In this case, the processor receives a load instruction with an entry. The processor performs the hierarchical search for the data associated with the entry by searching the first store queue 308. If the processor finds the entry in the first store queue 308, the processor can perform STLF at a relatively faster speed due to the smaller size of the first store queue 308 and the relatively lower amount of entries. If the processor determines that the value is not located in the first store queue 308, the processor searches the second store queue 310. The processor performs STLF one cycle slower at the second store queue 310 than at the first store queue 308 to reduce STLF timing pressure associated with the larger size of the second store queue 310 and the greater amount of entries in the second store queue 310.

In this implementation, the processor retires entries based on their locations with reference to the pointers in the first store queue 308 and the second store queue 310. The processor receives a store instruction to store a value 326 in the store queue 306. The store queue 306 receives the value 326 from the load reservation station 304. The processor determines whether to retire an older entry in the store queue 306 by determining whether the first store queue 308 is full (e.g., contains the limited amount of entries for the first store queue 308).

If the first store queue 308 is not full, the processor writes the value 326 to the store queue 306. If the first store queue 308 is full, the processor drains (e.g., moves) entry 312 to the second store queue 310. Entry 312 is the oldest entry in the first store queue 308, which is indicated by the first store queue head pointer 316. In some cases, the processor drains entry 312 in the first store queue 308 when the processor commits the entry.

If the second store queue is full, the processor can move retired entries 324 from the second store queue 310 to the store gather buffer 322. In some cases, the processor drains the retired entries 324 in the second store queue 310 when the processor commits the retired entries 324.

The processor writes the value 326 to the first store queue 308 at the first store queue tail pointer 314. By writing the value 326 to the first store queue 308, the processor can perform STLF more efficiently, since the processor is more likely to use the most recently added entries to forward data.

For example, a store queue 306 can have a store queue size of 128 entries. The first store queue 308 can contain 32 entries and the second store queue 310 can contain 96 entries. The processor can perform STLF more efficiently in the first store queue 308, as the first store queue 308 contains a relatively lower number of entries (e.g., 32 entries) than the second store queue 310 (e.g., 96 entries). Additionally, the first store queue 308 contains the youngest entries that are more likely to be used in STLF, which further increases the efficiency of the store queue 306.

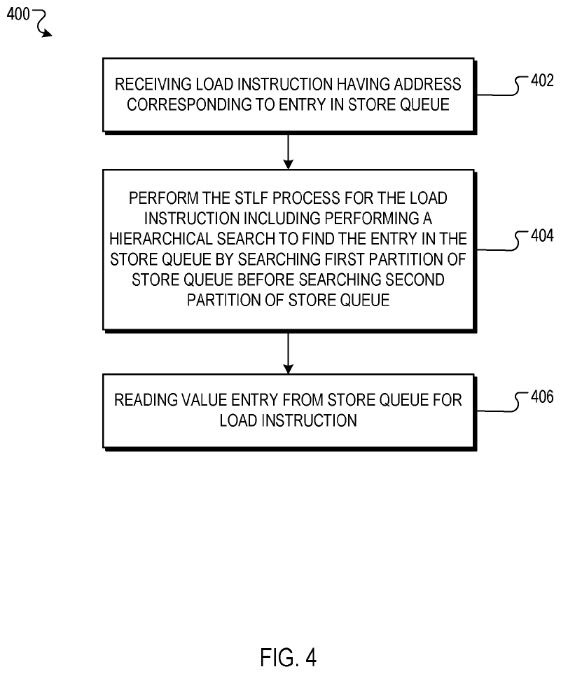

FIG. 4 is a flow diagram of an example process for performing a backend victimization process. For convenience, the process 400 will be described as being performed by a processor. For example, a processor, e.g., the processor 102 of FIG. 1, appropriately configured in accordance with this specification, can perform the process 400.

In some cases, the processor can receive a load instruction with an address corresponding to an entry in the hierarchical store queue (402). For example, with reference to FIG. 2, the processor receives the load instruction of an entry with an address of the store queue and a corresponding value located in the LSU. With reference to FIG. 3, the processor receives the load instruction with an address and a value corresponding to an entry located in the load reservation station of the LSU. In this case, the load reservation station sends the value to the store queue for the processor to perform STLF.

The processor performs the hierarchical search for the load instruction to find the entry in the store queue (404). The processor searches the hierarchical store queue to determine whether the data requested in the load instruction is present in the store queue. The processor searches the first partition of the store queue before searching the second partition of the store queue.

In one example, with reference to FIG. 2, the store queue is logically divided into the first partition and the second partition. In another example, with reference to FIG. 3, the store is physically divided into two separate store queue devices, where the first store queue device is the first partition, and the second store queue device is the second partition. In both cases, the first partition is relatively smaller than the second partition, and the processor can perform STLF relatively faster in the first partition than in the second partition because the processor has to search through less entries in the first partition than in the second partition.

The processor reads the value of the entry from the hierarchical store queue for the load instruction (406). If the processor finds the entry in either of the partitions, the processor can perform STLF by forward the value of the entry from the first partition or the second partition of the hierarchical store queue to the pending load instruction e.g., the processor can forward data from an active entry of the store queue instead of writing the data out to the main memory.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:
Embodiment 1 is a method performed on a processor using a hierarchical store queue comprising:
   receiving a load instruction having an address corresponding to an entry in the hierarchical store queue;
   performing a hierarchical search to find the entry in the hierarchical store queue, wherein performing the hierarchical search comprises searching a first partition of the hierarchical store queue for the entry before searching a second partition of the hierarchical store queue; and reading a value of the entry from the hierarchical store queue for the load instruction.
Embodiment 2 is the method of embodiment 1, wherein the first partition is smaller than the second partition.
Embodiment 3 is the method of any one of embodiments 1-2, wherein performing the hierarchical search comprises:
   performing a store-to-load forwarding process for the load instruction.
Embodiment 4 is the method of any one of embodiments 1-33, wherein the hierarchical store queue is a circular queue partitioned logically using a pointer that denotes a first entry to search in the first partition.
Embodiment 5 is the method of embodiment 4, wherein the pointer that denotes the first entry in the first partition is located at an offset from a tail pointer representing a most recently added entry in the hierarchical store queue.
Embodiment 6 is the method of embodiment 5, wherein performing the hierarchical search comprises:
   determining that the entry is not located in the first partition; and in response, searching the second partition from a location indicated by a head pointer, the head pointer representing the oldest entry in the hierarchical store queue.
Embodiment 7 is the method of embodiment 6, wherein the first partition ranges from the tail pointer to the pointer that denotes the first entry, and the second partition ranges from the pointer that denotes the first entry to the head pointer.
Embodiment 8 is the method of embodiment 5, wherein the offset is a store-to-load window of the store-to-load forwarding process.
Embodiment 9 is the method of embodiment 8, wherein a size of the store-to-load window is global to the processor or local to the load instruction of the store-to-load forwarding process.
Embodiment 10 is the method of embodiment 6, further comprising:
   receiving a store instruction to store a value in the hierarchical store queue; determining to retire an entry from the hierarchical store queue to a store gather buffer;
   retiring the entry to the store gather buffer in a first-in first-out manner, wherein the entry is the oldest entry indicated by the head pointer; and writing the value from the store instruction in the hierarchical store queue.
Embodiment 11 is the method of any one of embodiments 1-33, wherein the hierarchical store queue is partitioned physically using separate hierarchical store queue devices.
Embodiment 12 is the method of embodiment 11, wherein performing the hierarchical search comprises:
   determining that the entry is not located in the first partition; and in response, searching a second device implementing the second partition.
Embodiment 13 is the method of embodiment 12, wherein the first partition ranges from a first tail pointer to a first head pointer and the second partition ranges from a second tail pointer to a second head pointer, wherein the first tail pointer and the second tail pointer indicate the most recent entry in the respective partition, and the first head pointer and the second head pointer indicate the oldest entry in the respective partition.
Embodiment 14 is the method of embodiment 11, wherein performing the store-to-load forwarding process at the second partition is at least one cycle slower than performing the store-to-load forwarding process at the first partition.
Embodiment 15 is the method of embodiment 11, further comprising:
   receiving a store instruction to store a value in the hierarchical store queue; determining whether to retire an entry of the hierarchical store queue to a store gather buffer by determining whether the first partition and the second partition are full; and writing the value of the store instruction to the first partition or the second partition based on determining whether the first partition and the second partition are full.
Embodiment 16 is a system comprising a processor having a hierarchical store queue, wherein the processor is configured to perform the method of any one of embodiments 1-15.
Embodiment 17 is one or more storage media storing instructions that are operable, when executed by data processing apparatus, to cause the data processing apparatus to perform the method of any one of embodiments 1 to 15.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed on a processor using a hierarchical store queue, the method comprising:
receiving a load instruction having an address corresponding to an entry in the hierarchical store queue;
performing a hierarchical search to find the entry in the hierarchical store queue, wherein performing the hierarchical search comprises searching a first partition of the hierarchical store queue for the entry before searching a second partition of the hierarchical store queue; and
reading a value of the entry from the hierarchical store queue for the load instruction.

2. The method of claim 1, wherein the first partition is smaller than the second partition.

3. The method of claim 1, further comprising:
performing a store-to-load forwarding process for the load instruction.

4. The method of claim 1, wherein the hierarchical store queue is a circular queue partitioned logically using a pointer that denotes a first entry to search in the first partition.

5. The method of claim 4, wherein the pointer that denotes the first entry in the first partition is located at an offset from a tail pointer representing a most recently added entry in the hierarchical store queue.

6. The method of claim 5, wherein performing the hierarchical search comprises:
determining that the entry is not located in the first partition; and
in response, searching the second partition from a location indicated by a head pointer, the head pointer representing the oldest entry in the hierarchical store queue.

7. The method of claim 6, wherein the first partition ranges from the tail pointer to the pointer that denotes the first entry, and the second partition ranges from the pointer that denotes the first entry to the head pointer.

8. The method of claim 5, wherein the offset is a store-to-load window of the store-to-load forwarding process.

9. The method of claim 8, wherein a size of the store-to-load window is global to the processor or local to the load instruction of the store-to-load forwarding process.

10. The method of claim 6, further comprising:
receiving a store instruction to store a value in the hierarchical store queue;
determining to retire an entry from the hierarchical store queue to a store gather buffer;
retiring the entry to the store gather buffer in a first-in first-out manner, wherein the entry is the oldest entry indicated by the head pointer; and
writing the value from the store instruction in the hierarchical store queue.

11. The method of claim 1, wherein the hierarchical store queue is partitioned physically using separate hierarchical store queue devices.

12. The method of claim 11, wherein performing the hierarchical search comprises:
determining that the entry is not located in the first partition; and
in response, searching a second device implementing the second partition.

13. The method of claim 12, wherein the first partition ranges from a first tail pointer to a first head pointer and the second partition ranges from a second tail pointer to a second head pointer, wherein the first tail pointer and the second tail pointer indicate the most recent entry in the respective partition, and the first head pointer and the second head pointer indicate the oldest entry in the respective partition.

14. The method of claim 11, wherein performing the store-to-load forwarding process at the second partition is at least one cycle slower than performing the store-to-load forwarding process at the first partition.

15. The method of claim 11, further comprising:
receiving a store instruction to store a value in the hierarchical store queue;
determining whether to retire an entry of the hierarchical store queue to a store gather buffer by determining whether the first partition and the second partition are full; and
writing the value of the store instruction to the first partition or the second partition based on determining whether the first partition and the second partition are full.

16. A system comprising_a processor having a hierarchical store queue, wherein the processor is configured to perform operations comprising:
receiving a load instruction having an address corresponding to an entry in the hierarchical store queue;
performing a hierarchical search to find the entry in the hierarchical store queue, wherein performing the hierarchical search comprises searching a first partition of the hierarchical store queue for the entry before searching a second partition of the hierarchical store queue; and
reading a value of the entry from the hierarchical store queue for the load instruction.

17. One or more storage media storing instructions that are operable, when executed by data processing apparatus, to cause the data processing apparatus to perform operations comprising:
receiving a load instruction having an address corresponding to an entry in the hierarchical store queue;
performing a hierarchical search to find the entry in the hierarchical store queue, wherein performing the hierarchical search comprises searching a first partition of the hierarchical store queue for the entry before searching a second partition of the hierarchical store queue; and
reading a value of the entry from the hierarchical store queue for the load instruction.

18. The system of claim 16, wherein the first partition is smaller than the second partition.

19. The system of claim 16, wherein the operations further comprise:
performing a store-to-load forwarding process for the load instruction.

20. The one or more storage media storing instructions of claim 17, wherein the hierarchical store queue is a circular queue partitioned logically using a pointer that denotes a first entry to search in the first partition.
